(19) United States
(12) Patent Application Publication
(10) Pub. No.: US 2011/0002564 A1
(43) Pub. Date: Jan. 6, 2011

(54) SLIDE BEARING FOR HIGH ROTATION SPEEDS OF AN ANODE PLATE

(76) Inventors: Jan Essensohn, Erlangen (DE); Marc Hainke, Lauf a.d. Pegnitz (DE); Thomas Ohrndorf, Altendorf (DE); Marc Ordung, Effeltrich (DE); Bernhard Roas, Moehrendorf (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/829,567

(22) Filed: Jul. 2, 2010

(30) Foreign Application Priority Data
Jul. 2, 2009 (DE) 10 2009 031 530.6

(51) Int. Cl. F16C 32/06

(52) U.S. Cl. 384/100

(57) ABSTRACT

A slide bearing for a rotating anode has a stationary bearing part, and multiple rotatable bearing parts are arranged concentrically around the stationary bearing part or within the stationary bearing part. The bearing parts have bearing surfaces between which are located bearing gaps filled with a fluid medium. The sliding friction of slide bearings can be markedly lowered with fluids given rotation frequencies greater than 200 Hz. At the same time the excellent heat dissipation is retained.

### BACKGROUND OF THE INVENTION

1. Field of the Invention

The present invention concerns a slide bearing of the type having a stationary bearing part, at which an anode plate of an x-ray tube can be attached, as well as an x-ray tube and a computed tomography apparatus with such a slide bearing.

2. Description of the Prior Art

A slide bearing is a machine element or component that is based on sliding movements of a component on or in a bearing. In contrast to ball bearings and roller bearings, a slide bearing is characterized by respective surfaces of the component and the bearing moving past one another directly, or separated only by a lubricant film. Slide bearings are therefore generally dependent on excellent lubrication to counter sliding friction. The lubrication ensues using lubricating oils or lubricating greases, but also using soft metal bearings made of copper, bronze or tin or according to other self-lubricating principles.

Slice bearings are used for bearing a rotatable anode plate of an x-ray tube. In DE 196 12 693 A1 a slide bearing for a rotating anode is specified that has a rotating bearing part and a stationary bearing part with bearing surfaces between which is located a bearing gap filled with a fluid metal provided as a lubricant. Given the required rotation frequencies of less than 200 Hz, the slide bearing is sufficiently smooth-running and—through the large contact surfaces of the bearing parts—ensures a good heat conduction of the heat energy stored in the anode plate.

However, higher rotation frequencies of the anode plate will be required in future high-power x-ray tubes. The friction in a slide bearing rises superproportionally with the rotation frequency at rotation frequencies above 200 Hz, such that the power of the drive unit that is required to drive the rotating anode would no longer be acceptable.

### SUMMARY OF THE INVENTION

An object of the invention is to overcome this disadvantage and to specify a slide bearing that exhibits a good heat conductivity, a low sliding friction and sufficient bearing force even at high rotation frequencies.

According to the invention, the posed object is achieved by a slide bearing for a rotating anode of an x-ray tube, as well as an x-ray tube and a computed tomography apparatus with such a slide bearing wherein the slide bearing for a rotating anode has a stationary bearing part, wherein multiple rotatable bearing parts arranged concentrically around the stationary bearing part or within the stationary bearing part, and the bearing parts have structured (for example a groove structure) or unstructured bearing surfaces between which are located bearing gaps filled with a fluid medium, for example a fluid metal. It is advantageous that the sliding friction of slide bearings can be markedly lowered with fluids given rotation frequencies greater than 200 Hz. At the same time the advantage of the very good heat dissipation is maintained.

In an embodiment of the invention, the fluid metal can act as a lubricant and as a heat transport medium.

In a further embodiment, the rotating anode can be connected exclusively with the outermost or with the innermost rotatable bearing part.

The invention also encompasses an x-ray tube with a rotating anode that is borne by a slide bearing according to the invention.

Moreover, the invention encompassed a computed tomography apparatus with an x-ray tube according to the invention. The x-ray tube according to the invention can also be used in other x-ray devices (for example an angiography apparatus).

### BRIEF DESCRIPTION OF THE DRAWINGS

FIG. 1 is a cross section through a slide bearing according to the prior art.

FIG. 2 is a cross section through a slide bearing with two concentric bearing shells.

### DESCRIPTION OF THE PREFERRED EMBODIMENTS

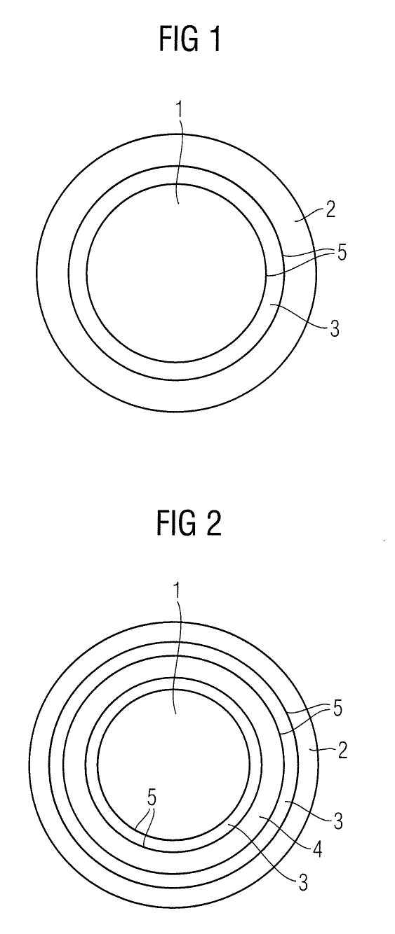

FIG. 1 shows a cross section through a slide bearing for an anode plate according to the prior art. Slide bearings are formed by an inner shaft 1 borne in a bearing shell 2. For example, the inner shaft 1 forms the stationary bearing part, contrary to which the bearing shell 2 forms the movable part. The anode plate is attached on the rotatable bearing shell 2. The inner shaft 1 is rigidly connected with an x-ray tube housing and can be cooled from the inside.

Located between the two concentrically arranged bearing parts 1, 2 is a bearing gap 3 (for example 20 μm wide, for example) formed by bearing surfaces 5 of the bearing parts 1, 2 and filled with a fluid metal, for example Ga-In-Sn. The friction in the bearing gap 3 (which friction is dependent on rotation speed) limits the rotation frequency for the anode plate to less than 200 Hz. One important advantage of slide bearings is a large-area contact between the bearing shell 2 and the bearing bushing 1 by means of the fluid film in the bearing gap 3. Approximately 90% of the heat energy accumulating in the anode plate can thereby be dissipated via a direct heat conduction.

A slide bearing according to the invention that is suitable for rotation frequencies of the anode plate that are higher than 200 Hz is shown in cross section in FIG. 2. An additional rotatable bearing part 4—the bearing bushing—is arranged concentrically between a stationary bearing part 1 (the journal) and a rotatable bearing part 2 (the bearing shell). Located between the bearing parts 1, 2, 4 are bearing gaps 3 (formed by bearing surfaces 5 of the bearing parts 1, 2, 4) that are filled with a fluid metal. Due to the creation of two concentric slide bearings, the rotatable bearing parts 2, 4 rotate with only half of the rotation frequency relative to one another.

Since, given hydrodynamic fluid metal bearings, the friction rises superproportionally with the rotation frequency, given a constant rotation frequency of the anode plate connected with the bearing shell the total friction of the double slide bearing possesses only a portion of the friction of the simple slide bearing. For example, if the friction of the simple slide bearing increases quadratically with the rotation frequency, the friction of the double slide bearing amounts to only half of this.

Since the bearing force rises linearly with the rotation frequency, at a rotation frequency of 400 Hz (2*200 Hz) a double slide bearing still possesses approximately the same bearing force as a simple slide bearing at a rotation frequency of 200 Hz.

The journal 1 can be internally or, respectively, externally cooled for an improved heat dissipation.

Additional rotatable bearing parts can be inserted for a further reduction of the bearing friction, whereby a slide bearing is formed in layers.

Although modifications and changes may be suggested by those skilled in the art, it is the intention of the inventors to embody within the patent warranted hereon all changes and modifications as reasonably and properly come within the scope of their contribution to the art.

We claim as our invention:

1. A slide bearing for a rotating anode of an x-ray tube, said slide bearing comprising:
a stationary bearing part adapted for attachment to a stationary part of an x-ray tube;
multiple rotating bearing parts, at least one of said multiple rotating bearing parts being adapted for connection to a rotating anode of said x-ray tube;
said multiple rotating bearing parts being arranged concentrically around said stationary bearing part or concentrically within said stationary bearing part;
each of said stationary bearing part and said multiple rotatable bearing parts having a bearing surface, with respective bearing gaps being located between the respective bearing surfaces of said multiple rotating bearing parts and said stationary bearing part; and
a fluid medium filling said bearing gaps.

2. A slide bearing as claimed in claim 1 wherein said fluid medium is a fluid metal having both lubricating and heat transport properties.

3. A slide bearing as claimed in claim 1 wherein said multiple bearing parts include an innermost rotatable bearing part, and wherein said rotating anode is connected only to said innermost rotatable bearing part.

4. A slide bearing as claimed in claim 1 wherein said multiple bearing parts include an outermost rotatable bearing part, and wherein said rotating anode is connected only to said outermost rotatable bearing part.
